(19) United States
(12) Patent Application Publication
(10) Pub. No.: US 2009/0116914 A1
(43) Pub. Date: May 7, 2009

(54) DEVICE FOR MACHINING THE END OF A TUBULAR MEMBER

(75) Inventors: Stephan Rieth, St. Wendel (DE); Frederic Legrand, Livron Sur Drome (FR)

Correspondence Address: HESLIN ROTHENBERG FARLEY & MESITI PC, 5 COLUMBIA CIRCLE, ALBANY, NY, 12203, US

(73) Assignee: Axxair, Etoile Sur Rhone (FR)

(21) Appl. No.: 12/066,502

(22) PCT Filed: Sep. 8, 2006
(86) PCT No.: PCT/FR2006/050859

§ 371 Date: Jul. 23, 2008

(30) Foreign Application Priority Data
Sep. 12, 2005 (FR) 0552738

(51) Int. Cl. B23G 1/22

(52) U.S. Cl. 408/104

(57) ABSTRACT

A device for machining an end of a tubular member comprises: a clamping element for clamping the tubular member to maintain same in a fixed position; a movement imparting element for imparting a circular movement to a driving member about the end of the tubular member; a milling cutter driven in rotation by the driving member and including carbide inserts to perform machining under the combined effect of the circular movement of the driving member and the rotational movement of the milling cutter.

The invention relates to the technical field of metal working, in particular machining operations, and more particularly operations of bevelling and/or cutting performed at the end of any tubular member.

Various technical solutions can be used to perform this type of machining operation. In particular, this machining at the end of a tubular member can be performed using HSS machine tools. The solutions proposed are not fully satisfactory, particularly in terms of machining time.

For example, it is possible to use traditional high-speed steel tools, known to a person skilled in the art by the acronym HSS, which must be rotated about the tubular member which is fixed. In this case, it is necessary to rotate the tools at a speed appropriate to the material to be machined.

These HSS tools can be replaced by tools with carbide tips which should also be rotated at high speeds. This raises the need to use a machine having high dimensional and stiffness characteristics.

It is also being proposed to use a shaping cutter, rotated by a drive member which can be subject to means for being moved about the tubular member to be bevelled. One solution of this type appears for example from the teaching of patent FR 2802134. The toothing of the cutter used generates a large number of shavings, so that it is not possible to move the drive member rapidly around the tube, making the machining operation relatively lengthy. The same drawbacks are found in the solution disclosed by the teaching of patent DE 19603361.

It is the object of the invention to remedy these drawbacks simply, safely, effectively and efficiently.

The problem that this invention proposes to solve is to be able to carry out a machining of the orbital type at very high speed, with the possibility of using a compact and lightweight portable or fixed machine, the said machining being advantageously a bevelling and/or a cutting and other machinings at the end of a tubular member. The invention allows the use of very high cutting speeds in m/min, about ten times higher than the techniques commonly used (HSS or other).

To solve this problem, a device has been designed and developed comprising:

means for clamping the tubular member to maintain it in a fixed position;

means for circularly moving a drive member about the end of the tubular member;

a cutter rotated by the drive member and having carbide tips for performing the machining operation under the combined action of the circular movement of the drive member and the rotation of the said cutter.

Advantageously, considering the problem to be solved, each carbide tip used is of the type of those having technical properties conforming to or equivalent to those described in international patent application WO 2004/078395.

Considering the teaching of the abovementioned international application and considering the problem to be solved, the cutter consists of a head coupled with a drive member, the said head having one side with recesses for the angular mounting of the carbide tips.

The carbide tips are profiled into a cross section for bounding cutting faces comprising at least two straight segments positioned angularly to perform the machining operation in the form of cutting and/or bevelling.

In an advantageous embodiment of the invention, the means for clamping the tubular member consist of clamping jaws and the means for circularly moving the drive member form part of a machine comprising:

a clamping plate rotatingly mounted on one side of a fixed part, the said plate and the said part being drilled coaxially in order to arrange an opening for engaging the tubular member;

the fixed part has arrangements for mounting with guided translation travel capacity of the clamping jaws terminating in the opening under the action of the circular drive of the clamping plate;

on the other side of the fixed part, and in coaxial alignment, a rotating support plate is mounted, receiving a ring mounted with capacity for circular movement and for locking in position with regard to the said plate;

the ring has arrangements for receiving the drive member;

the combination of the plate and the ring are mounted with capacity for circular movement, manual or automatic, with regard to the tubular member clamped between the jaws, to subject the said member to the action of the carbide tips of the cutter under the action of the said movement combined with the rotation of the said cutter.

The invention is described below in greater detail in conjunction with the figures in the appended drawings in which:

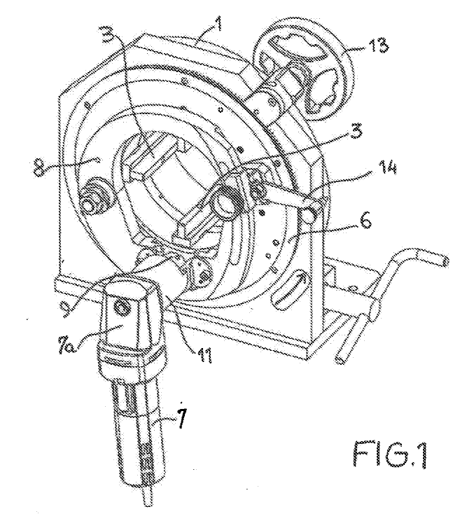

FIG. 1 is a perspective view of an exemplary embodiment of a machine implementing the device according to the invention;

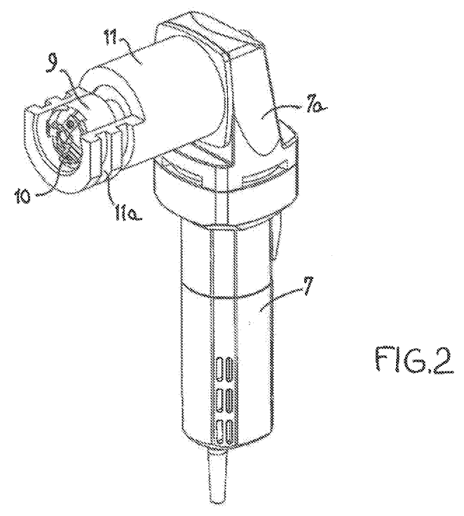

FIG. 2 is a perspective view of an embodiment of the drive motor equipped with a cutter with carbide tips;

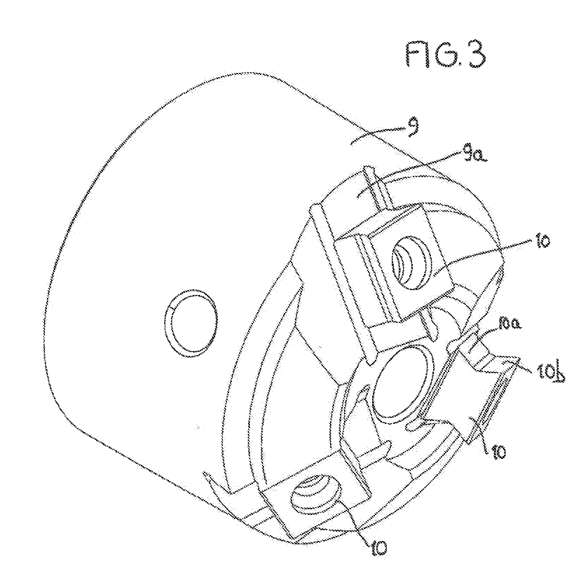

FIG. 3 is a perspective view of an embodiment of the cutting head with carbide tips according to the invention;

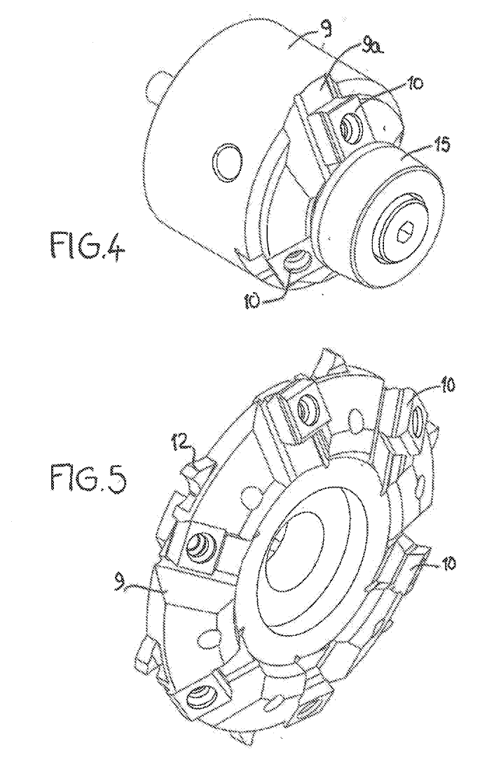

FIG. 4 is a view similar to FIG. 3 of a cutting head equipped with a bearing member;

FIG. 5 is another embodiment of the cutter arranged with carbide tips to be used, according to the invention, for performing the bevelling operation, in combination with the cutting tips.

As shown in the figures of the drawings, for information and non-limiting, an exemplary embodiment of the device for machining the end of a tubular member has the form of a machine suitable for performing an orbital machining, in a manner known per se.

This type of machine, as it appears, for example, from the teaching of the abovementioned patent FR 2802134, comprises a plate (1) positioned vertically and tangentially facing a fixed part (2). The plate (1) is rotatingly mounted with regard to the fixed part (2) which may consist of a part of the machine frame. The plate (1) and the part (2) have a central opening for the engagement of the tubular member (not shown). The fixed part (2) has arrangements for mounting, with guided translation travel capacity, of clamping jaws (3). For example, the movement of the clamping jaws (3) takes place concentrically with the tubular member.

One solution for the movement of the clamping jaws appears, for example, from the teaching of patent FR 2 771 319.

On the other side of the fixed part (2), the machine is equipped, coaxially with the rotating plate (1), with another rotating plate (6) for the orbital circular movement of a drive member (7) with regard to the tubular member clamped between the jaws (3). The fixed part (2) and the plate (6) are placed in parallel planes, particularly vertical.

The drive means (13) of the rotating plate (6) for the circular movement of the cutter drive above the tube may be either manual or motorized.

It should be noted that the rotating plate (6) can receive, off-centred or not, a ring (8) mounted with capacity for circular movement and locking in position with regard to the said plate (6). In this case, the ring (8) has arrangements for removably mounting the drive member (7).

According to one basic feature of the invention, the drive member receives a cutter (9), angular or cylindrical, and having carbide tips (10). More particularly, the cutter consists of a head coupled to the drive shaft of the drive member (6) and having one face (9a) with recesses (9b) for the angular mounting, with removal capacity, of the carbide tips (10). The face (9a) of the cutter has at least two carbide tips (10). Advantageously, this face (9a) has three carbide tips (10) uniformly offset by 1700 on a circumference.

As shown in particular in FIGS. 1 and 2 of the drawings, the cutter (9) maybe mounted in a semi-open shell (11) securely joined to the casing (7a) of the drive member (7). The semi-open shell (11) has arrangements (11a) for its coupling with the ring (8), so that the carbide tips (10) performed the machining operation on the end of the tubular member under the combined action of the circular movement of the drive member (7) and the rotation of the cutter (9).

Each carbide tip (10) is profiled into a cross section to bound cutting faces comprising at least two straight segments (10a) and (10b) positioned angularly to perform the machining operation in the form of a cutting and/or a bevelling. The characteristics of the carbide tips (10) are advantageously of the type of those defined by the teaching of international application WO 2004/078395.

The carbide tips (10) may be positioned in a plurality of angles, with various combinations, in order to bevel, cut, countersink, rectify, or other machining operations desired at the end of the tubular member. Reference can be made, for example, to FIG. 5, which shows a cutter (9) with bevelling carbide tips (10) and cutting tips (12).

In the embodiment shown in FIG. 4, the cutter (9) is equipped with a bearing member (15) in the form of a roller, for example. These arrangements allow a tracking of the machining on the outer skin of the tubular member, with a necessary elastic resultant given by the lever (14) controlling the ring (8), the roller (15) exerting a continuous thrust. This tracking serves to preserve the same welding “root face” characteristic on the whole periphery of the tube, even if it is not perfectly circular but slightly oval.

The drive member (7), for driving the cutter (9), may be electrical, pneumatic or hydraulic.

The advantages clearly appear from the description, in particular emphasizing that the specificity of the carbide tips enables the assembly to operate optimally with the possibility of using high speeds, without requiring large scale mechanical arrangements, in terms of the overall size and dimensional characteristics. The quality of the machining obtained is also emphasized.

1. Device for machining an end of a tubular member, comprising:
means for clamping the tubular member to maintain the tubular member in a fixed position;
means for circularly moving a drive member about the end of the tubular member; and
a cutter rotated by the drive member and having carbide tips for performing a machining operation under combined action of circular movement of the drive member and rotation of the said cutter.

2. Device according to claim 1, wherein the cutter is angular and comprises a head coupled with a drive member, said head having one side with recesses for angular mounting of the carbide tips.

3. Device according to claim 1, wherein the carbide tips are profiled into a cross section for bounding cutting faces comprising at least two straight segments positioned angularly to perform the machining operation in a form of cutting and/or bevelling.

4. Device according to claim 1, wherein the means for clamping the tubular member comprises clamping jaws and the means for circularly moving the drive member form part of a machine comprising
a clamping plate rotatingly mounted on one side of a fixed part, said plate and the part being drilled coaxially in order to arrange an opening for engaging the tubular member;
the fixed part has arrangements for mounting with guided translation travel capacity of the clamping jaws terminating in the opening under the action of the circular drive of the clamping plate;
on an other side of the fixed part, and in coaxial alignment, a rotating support plate is mounted, receiving a ring mounted with capacity for circular movement and for locking in position with regard to said plate;
the ring has arrangements for receiving the drive member;
combination of the plate and the ring are mounted with capacity for circular movement, manual or automatic, with regard to the tubular member clamped between the jaws, to subject said member to action of the carbide tips of the cutter under the action of said movement combined with the rotation of the said cutter.
